(19) United States
(12) Patent Application Publication
(10) Pub. No.: US 2020/0110287 A1
(43) Pub. Date: Apr. 9, 2020

(54) EYEGLASSES HAVING DETACHABLE LENS UNIT

(71) Applicant: York TSAI, New Taipei City (TW)

(72) Inventor: York TSAI, New Taipei City (TW)

(21) Appl. No.: 16/390,309

(22) Filed: Apr. 22, 2019

(30) Foreign Application Priority Data
Oct. 9, 2018 (TW) 107135610

(51) Int. Cl. G02C 7/08; G02C 1/02

(52) U.S. Cl. CPC G02C 7/088; G02C 1/02

(57) ABSTRACT

Eyeglasses include a frame having a frame main body defining a receiving slot, a fastener having a rectangular body segment exposed from the receiving slot, and a lens unit including two lens portions and a connecting portion having a receiving notch. The fastener is rotatable at a predetermined angle relative to the frame between a first position, in which the lens unit can be inserted into or removed from the rectangular body segment through an opening of the receiving notch and can be inserted into or detached from the receiving slot through the lens portions; and a second position, in which the rectangular body segment is received and retained in the receiving notch, and the lens unit is fastened to the frame.

### CROSS-REFERENCE TO RELATED APPLICATION

This application claims priority to Taiwanese Patent Application No. 107135610, filed on Oct. 9 2018.

### FIELD

The disclosure relates to eyeglasses, more particularly to eyeglasses having a lens unit that can be quickly attached to and detached from a frame thereof.

### BACKGROUND

Referring to FIGS. 1 and 2, existing eyeglasses 1 include a frame 11, a lens unit 12 and a connecting member 117. The frame 11 includes a lens support 111 and two temples 116 pivoted to two opposite ends of the lens support 111. The lens support 111 has a central portion 112 provided with a horizontal stop plate 114 and a vertical stop plate 115 for respectively abutting against a top end and a lateral end of the center of the lens unit 12, and a plurality of stud holes 113 spaced apart from each other along the length of the central portion 112. The center of the lens unit 12 has a protruding portion 121 protruding forwardly from the top end thereof. The connecting member 117 has a positioning groove 118 for engagingly receiving the protruding portion 121 of the lens unit 12, and a plurality of positioning studs 119 for respective engagement with the stud holes 113 to thereby fix the lens unit 12 to the frame 11.

However, because the existing eyeglasses 1 have a complicated structure, the attachment and detachment of the lens unit 12 to and from the frame 11 are complicated and slow.

### SUMMARY

Therefore, an object of the disclosure is to provide eyeglasses having a lens unit that can be quickly attached to and detached from a frame thereof.

Accordingly, eyeglasses of this disclosure include a frame, a fastener and a lens unit. The frame includes a frame main body, an engaging portion and a covering portion. The frame main body includes a front wall, a rear wall opposite to the front wall, and a top wall connected between top ends of the front and rear walls and cooperating with the front and rear walls to define a receiving slot having a downward opening. The engaging portion extends downwardly from the rear wall and has a front surface, a rear surface opposite to the front surface, and a pivot hole extending through the front and rear surfaces. The covering portion extends downwardly from the front wall and has an engaging groove formed in an inner surface thereof and facing the pivot hole. The frame has a center line extending in a top-bottom direction. The pivot hole has a first length extending along the center line, and a second length extending along a transverse line perpendicular to the center line and shorter than the first length.

The fastener is rotatably connected to the frame and includes a fastener main body having an abutment surface abutting against the rear surface of the engaging portion, a protruding rod protruding from the abutment surface and rotatably received in the pivot hole, and a rectangular body segment that is connected to the protruding rod opposite to the abutment surface, that extends out of the pivot hole and that is exposed from the receiving slot. The rectangular body segment has an engaging piece protruding therefrom and engaged to the engaging groove. The fastener has a center line parallel to the center line of the frame. The rectangular body segment has a first length extending along the center line of the fastener, and a second length extending along a transverse line perpendicular to the center line of the fastener. The first length of the rectangular body segment is substantially equal to the second length of the pivot hole, while the second length thereof is shorter than the first length of the pivot hole.

The lens unit is detachably connected to the frame and includes two lens portions having top edges received in the receiving slot, and a connecting portion connected between the lens portions and having a receiving notch formed in a top edge thereof. The receiving notch has an opening with a width substantially equal to the first length of the rectangular body segment, and a receiving section with a hole diameter that is larger than the width of the opening and that is substantially equal to the second length of the rectangular body segment.

The fastener is rotatable at a predetermined angle relative to the frame between a first position, in which the second length of the rectangular body segment is parallel to the first length of the pivot hole, the receiving notch can be inserted into or removed from the rectangular body segment through the opening thereof, and the lens unit can be inserted into or removed from the rectangular body segment through the opening of the receiving notch and can be inserted into or detached from the receiving slot of the frame through the lens portions; and a second position, in which the second length of the rectangular body segment is perpendicular to the first length of the pivot hole, the rectangular body segment is received and retained in the receiving section of the receiving notch, and the lens unit is fastened to the frame.

### BRIEF DESCRIPTION OF THE DRAWINGS

Other features and advantages of the present disclosure will become apparent in the following detailed description of the embodiment with reference to the accompanying drawings, of which:

FIG. 1 is a perspective view of existing eyeglasses;

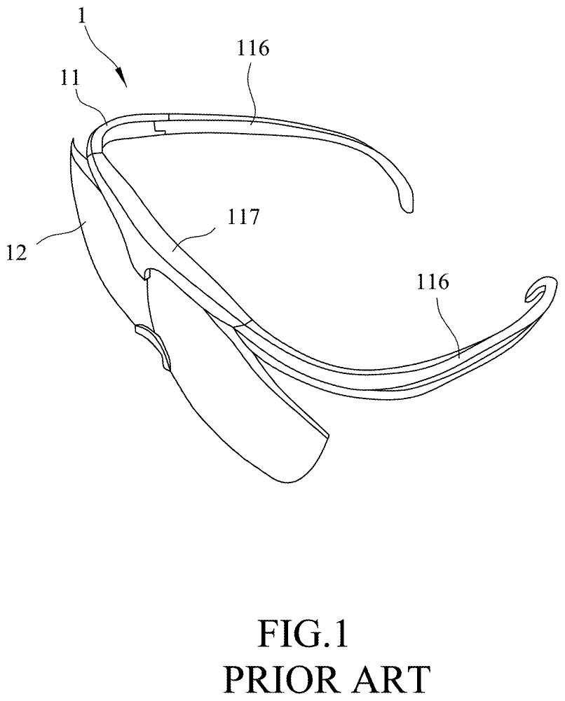

FIG. 2 is an exploded perspective view of the existing eyeglasses;

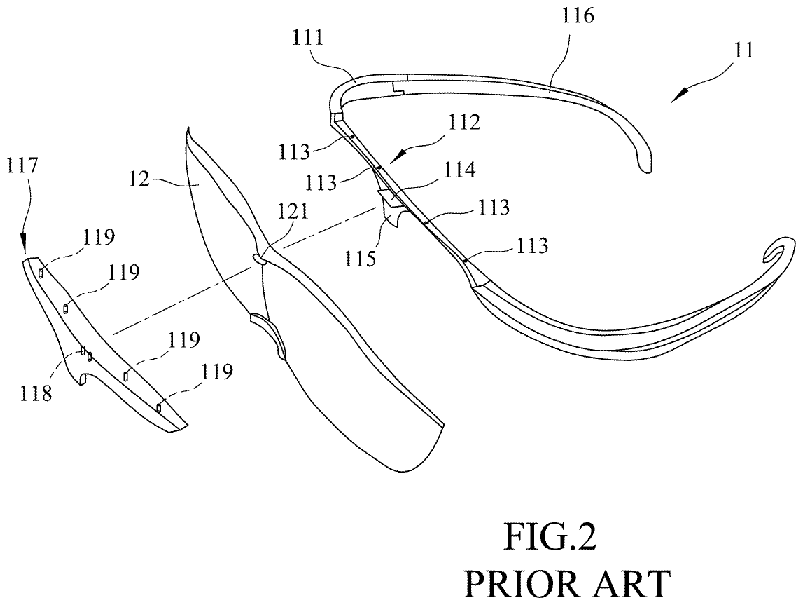

FIG. 3 is a perspective view of eyeglasses according to the embodiment of the present disclosure;

FIG. 4 is a front view of the embodiment;

FIG. 5 is an exploded perspective view of the embodiment, but without the temples;

FIG. 6 is a fragmentary front view of a frame of the embodiment;

FIG. 7 is a fragmentary rear view of the frame of the embodiment;

FIG. 8 is a fragmentary bottom view of the frame of the embodiment;

FIG. 9 is an enlarged perspective view of a fastener of the embodiment;

FIG. 10 is a front view of the fastener of the embodiment;

FIG. 11 is a side view of the fastener of the embodiment;

FIG. 12 is another perspective view of the fastener of the embodiment taken from another angle;

FIG. 13 is an exploded perspective view of the frame and the fastener of the embodiment;

FIG. 14 is an assembled bottom view of FIG. 13;

FIG. 15 is a partly sectional perspective view of the frame and the fastener in a state in which a rectangular body segment of the fastener is inserted into a pivot hole of an engaging portion of the frame;

FIG. 16 is a view similar to FIG. 15, but illustrating an engaging piece of the rectangular body segment being engaged to an engaging groove of a covering portion of the frame;

FIG. 17 is a fragmentary partly exploded front view of the embodiment, illustrating how a lens unit of the embodiment can be connected to the frame;

FIG. 18 is a fragmentary assembled rear view of the embodiment, illustrating the lens unit being connected to the frame;

FIG. 19 is a view similar to FIG. 18, but with the fastener being rotated to a predetermined angle to fasten the lens unit to the frame;

FIG. 20 is a partly sectional side view of the frame and the fastener in the assembled state;

FIG. 21 is a partly sectional front view of the frame and the fastener in the assembled state;

FIG. 22 is a fragmentary rear view of the frame of a first alternative form of the embodiment;

FIG. 23 is a bottom view of FIG. 22;

FIG. 24 is a perspective view of the fastener of the first alternative form of the embodiment;

FIG. 25 is a front view of FIG. 24;

FIG. 26 is a side view of FIG. 24;

FIG. 27 illustrates the frame and the fastener of the first alternative form of the embodiment in an assembled state; and

FIG. 28 is a partly exploded front view of a second alternative form of the embodiment.

### DETAILED DESCRIPTION

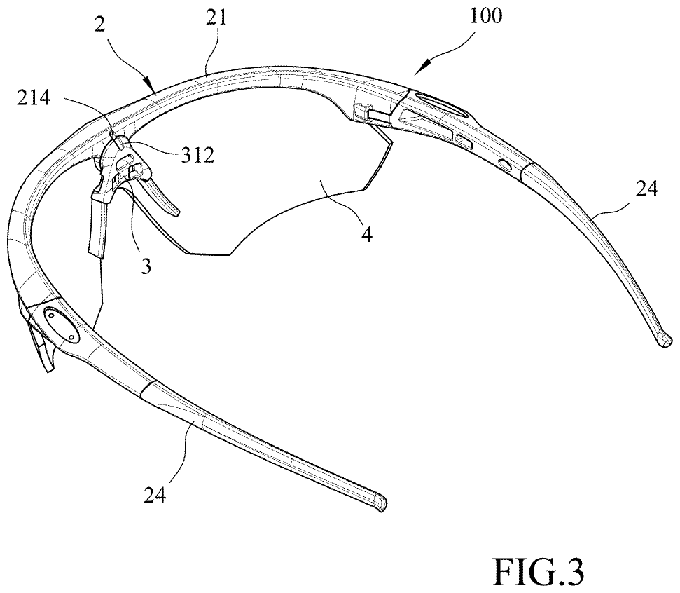

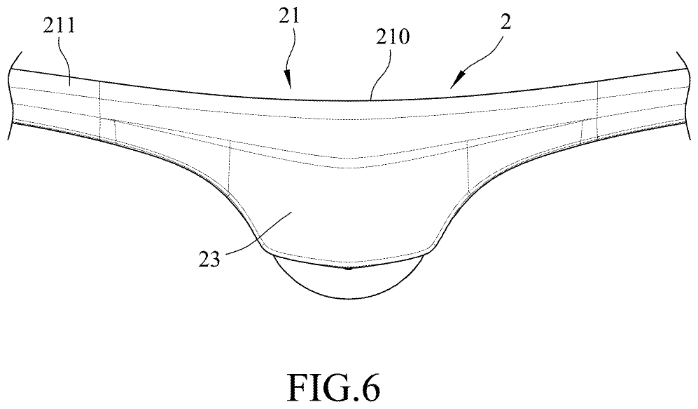

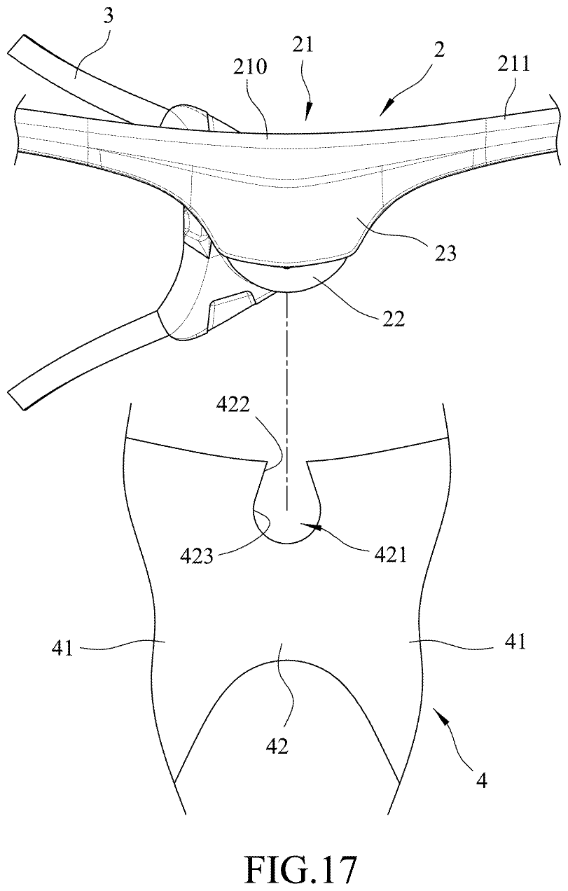

Referring to FIGS. 3 to 8 and 17, eyeglasses 100 according to an embodiment of the present disclosure is shown to comprise a frame 2, a fastener 3, and a lens unit 4.

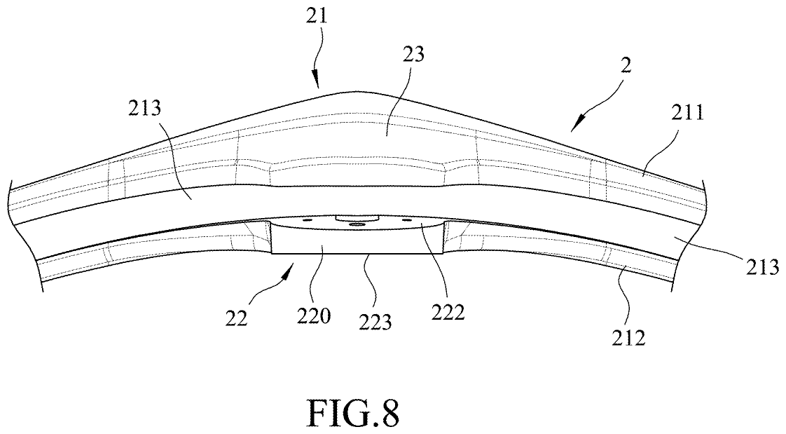

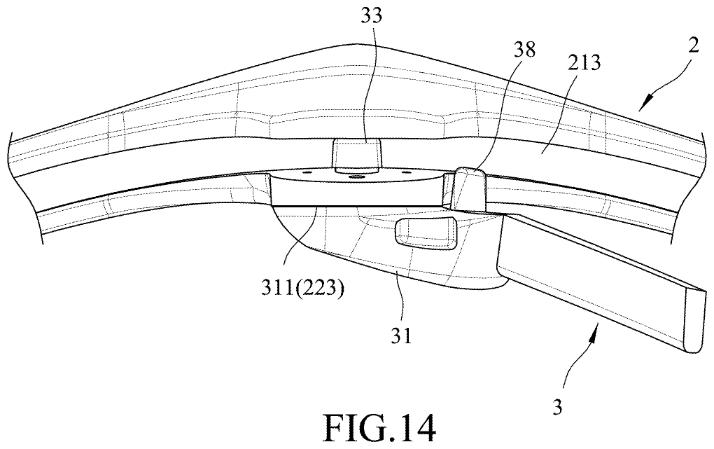

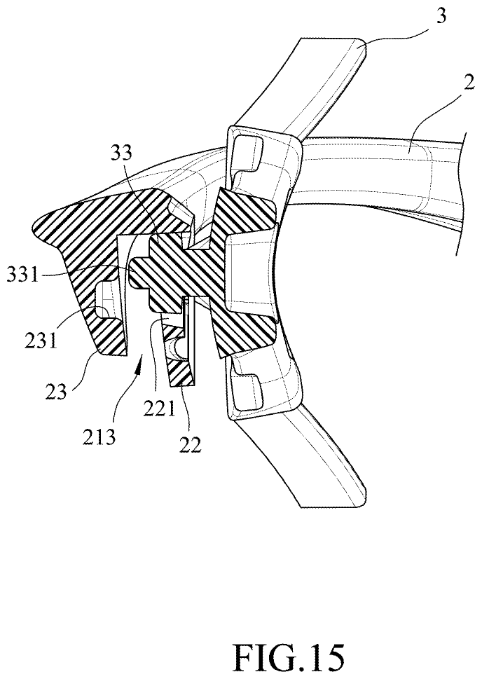

The frame 2 includes a frame main body 21, an engaging portion 22, a covering portion 23, and two temples 24 pivoted to two opposite ends of the frame main body 21. The frame main body 21 includes a front wall 211, a rear wall 212 opposite to the front wall 211, and a top wall 210 connected between top ends of the front and rear walls 211, 212. The front, rear and top walls 211, 212, 210 cooperatively define a receiving slot 213 having a downward opening (see FIGS. 8, 14 and 15). In this embodiment, the rear wall 212 is formed with a first alignment groove 214 at the center thereof.

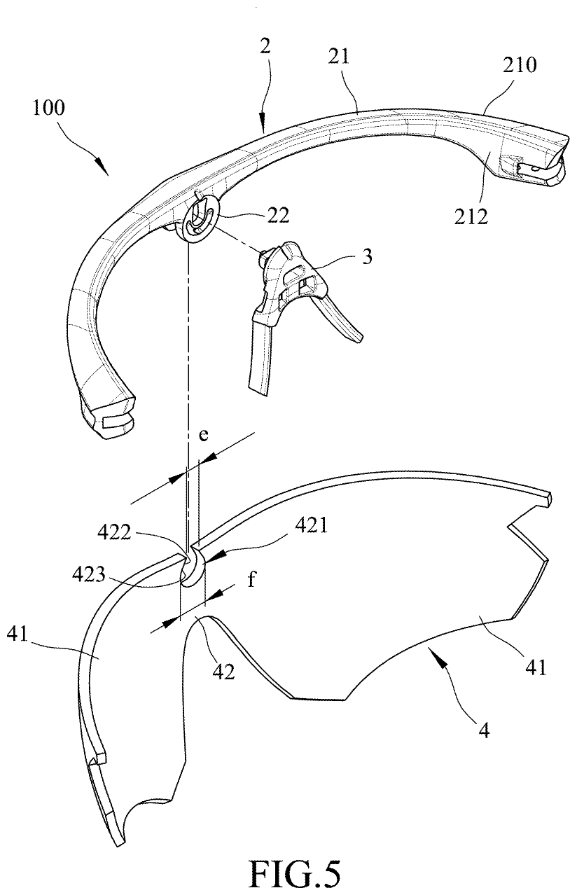

With reference to FIGS. 5, 7 and 8, the engaging portion 22 extends downwardly and integrally from the rear wall 212, and has a semicircular shape. The engaging portion 22 has a front surface 222 flush with an inner surface of the rear wall 212, a rear surface 223 opposite to the front surface 222 and flush with an outer surface of the rear wall 212, a bottom surface 220 connected between the front and rear surfaces 222, 223, a pivot hole 221 extending through the front and rear surfaces 222, 223, and a substantially U-shaped slide groove 226 formed in the rear surface 223 and located below the pivot hole 221.

The frame 2 has a center line (X) extending in a top-bottom direction. The pivot hole 221 has a first length (a) extending along the center line (X), and a second length (b) extending along a transverse line (Y) perpendicular to the center line (X) and shorter than the first length (a). The transverse line (Y) extends in a left-right direction. The engaging portion 22 further has a first positioning groove 224 formed in the center of a groove bottom of the slide groove 226, and two second positioning grooves 225 formed in the groove bottom of the slide groove 226 at two circumferential ends thereof. The first positioning groove 224 is located between the second positioning grooves 225. The second positioning grooves 225 are located at two opposite sides of the bottom end of the pivot hole 221.

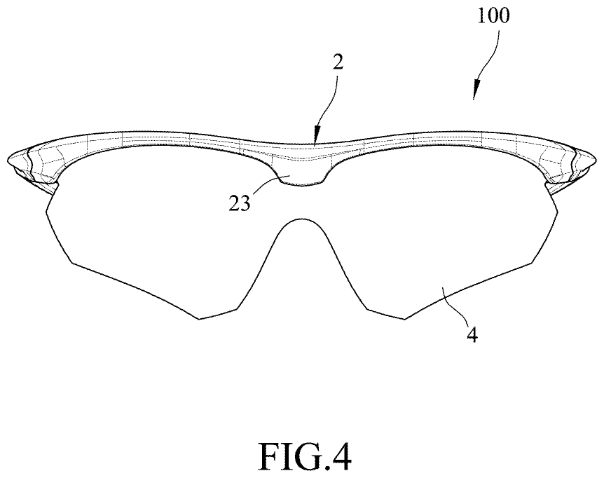

With reference to FIGS. 4, 6, 8, 15 and 16, the covering portion 23 extends downwardly and integrally from the front wall 211, and has an engaging groove 231 formed in an inner surface thereof and facing the pivot hole 221.

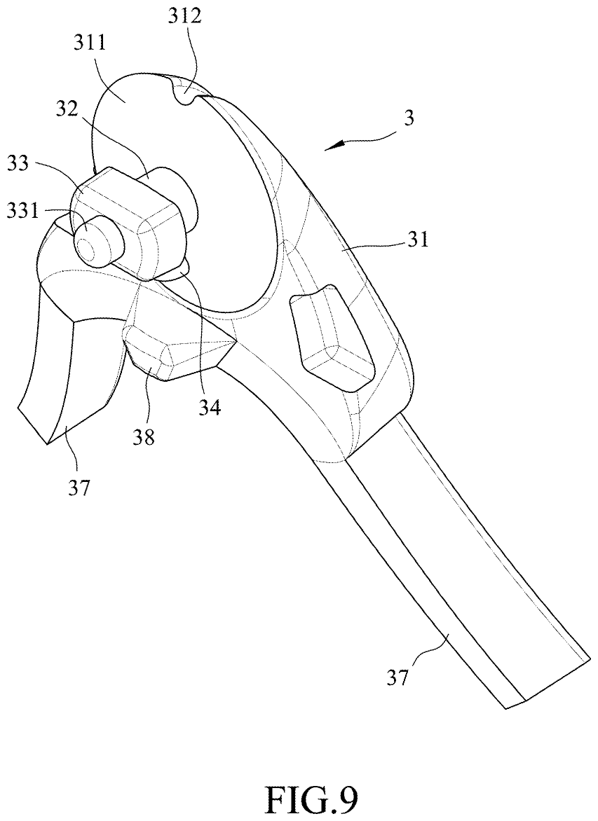

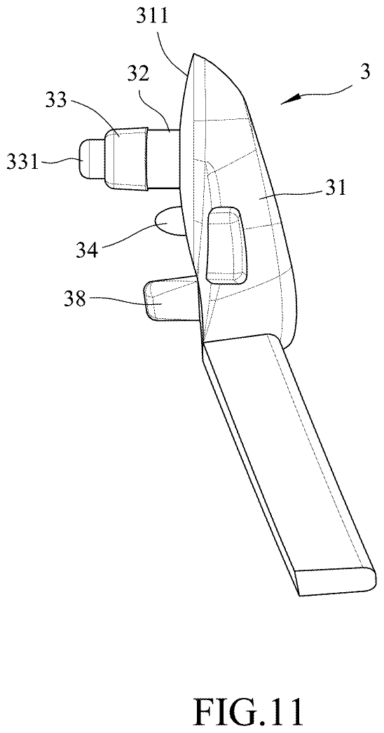

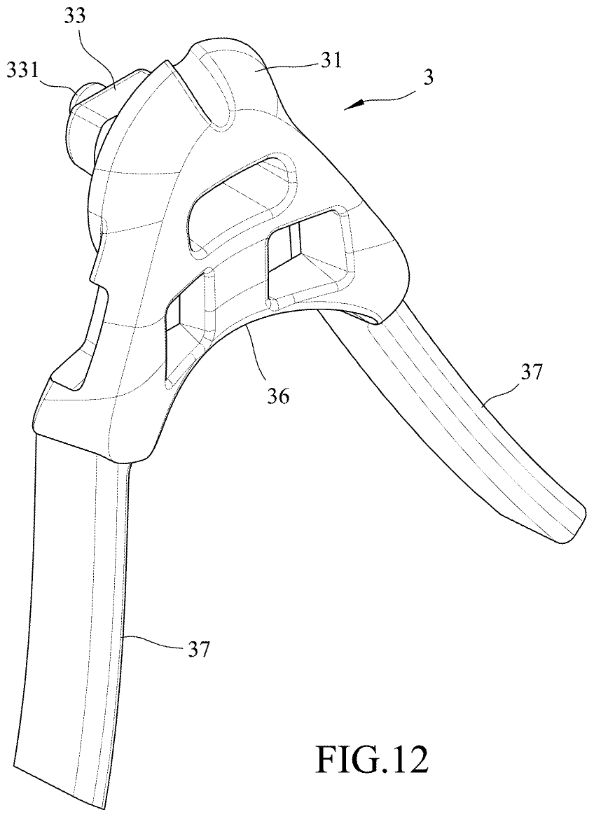

Referring to FIGS. 9 to 12, in this embodiment, the fastener 3 includes a fastener main body 31, a protruding rod 32, a rectangular body segment 33, a positioning stud 34, a protruding block 38, a nose bridge portion 36, and two nose pads 37.

The fastener main body 31 has an abutment surface 311 facing forwardly, and a top surface formed with a second alignment groove 312 at the center thereof and corresponding to the first alignment groove 214.

The protruding rod 32 protrudes outwardly and forwardly from the center of the abutment surface 311, and has an outer diameter smaller than the second length (b) of the pivot hole 221 so as to be rotatably received in the pivot hole 221.

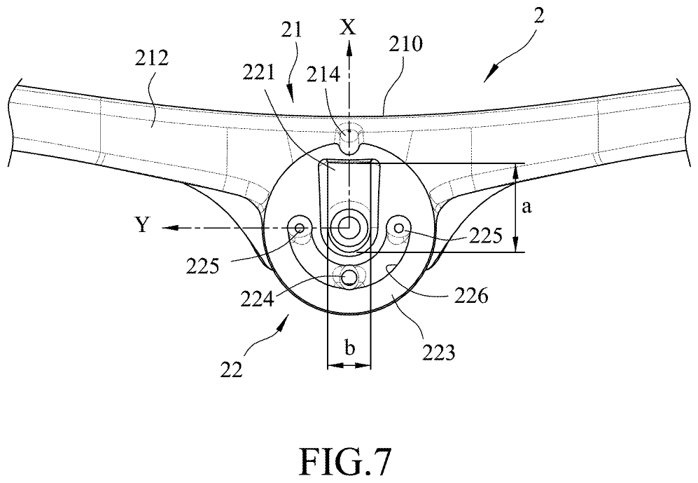

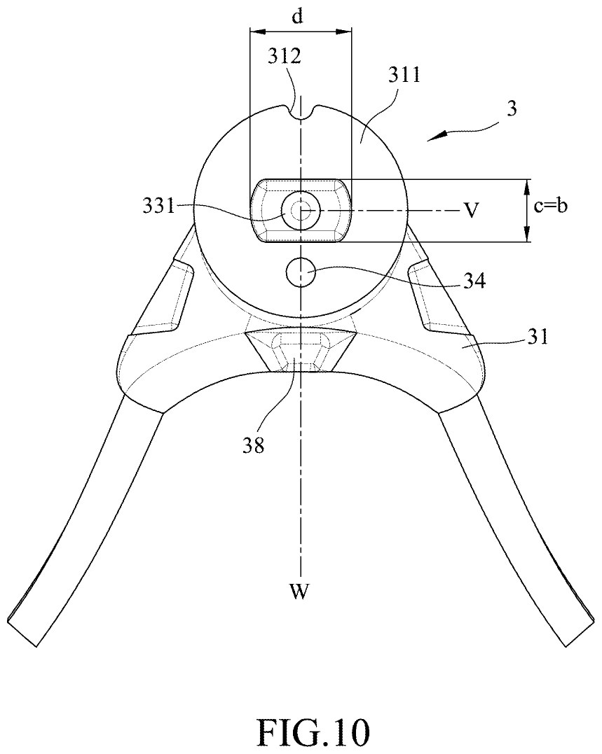

The rectangular body segment 33 is connected to the protruding rod 32 opposite to the abutment surface 311, and has an engaging piece 331 protruding outwardly and forwardly therefrom and opposite to the protruding rod 32 for engagement with the engaging groove 231. As shown in FIG. 10, the fastener 3 has a center line (W) parallel to the center line (X) (see FIG. 7) of the frame 2. The rectangular body segment 33 has a first length (c) extending along the center line (W), and a second length (d) extending along a transverse line (V) perpendicular to the center line (91). In this embodiment, the first length (c) of the rectangular body segment 33 is substantially equal to the second length (b) (see FIG. 7) of the pivot hole 221, while the second length (d) thereof is shorter than the first length (a) (see FIG. 7) of the pivot hole 221.

The positioning stud 34 protrudes outwardly and forwardly from the abutment surface 311 and is located below the protruding rod 32. The positioning stud 34 is used for engaging with one of the first and second positioning grooves 224, 225.

The protruding block 38 protrudes outwardly and forwardly from a bottom end of the fastener main body 31 and is located below the positioning stud 34. The protruding block 38 is slidable along the bottom surface 220 of the engaging portion 22 when the fastener 3 is assembled to the frame 2.

The nose bridge portion 36 is formed at the bottom end of the fastener main body 31 opposite to the protruding block 38.

The nose pads 37 extend downwardly from two opposite ends of the nose bridge portion 36 away from each other.

The fastener 3 of this disclosure may be combined with other relevant components of the nose portion of the eyeglasses 100 to form a single component.

With reference to FIG. 5, in this embodiment, the lens unit 4 includes two lens portions 41 and a connecting portion 42 connected between the lens portions 41. The connecting portion 42 has a receiving notch 421 formed in a top edge thereof. The receiving notch 421 has an opening 422 with a width (e) substantially equal to the first length (c) of the rectangular body segment 33, and a receiving section 423 with a hole diameter (f) that is larger than the width (e) of the opening (422) and that is substantially equal to the second length (d) of the rectangular body segment 33. In this embodiment, the lens portions 41 and the connecting portion 42 are integrally formed as a single shield lens.

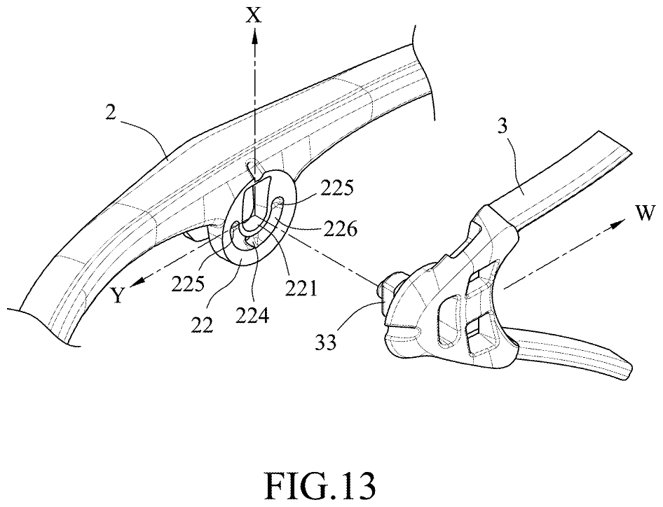

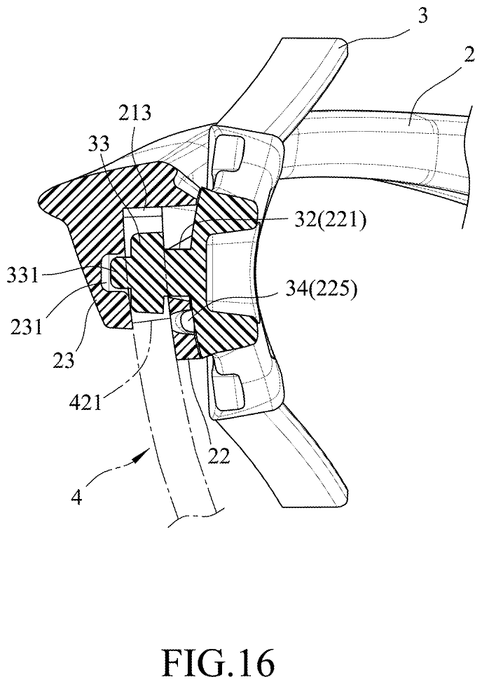

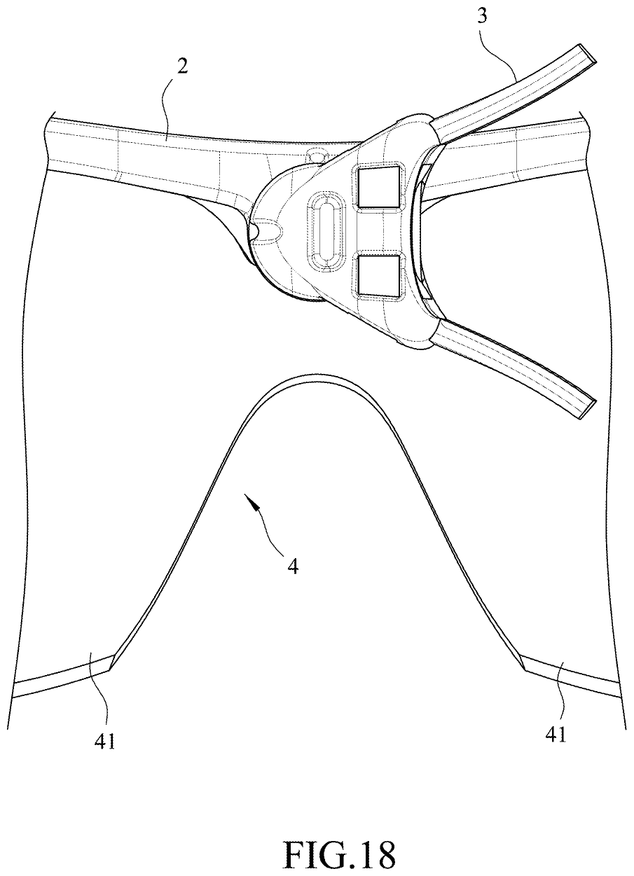

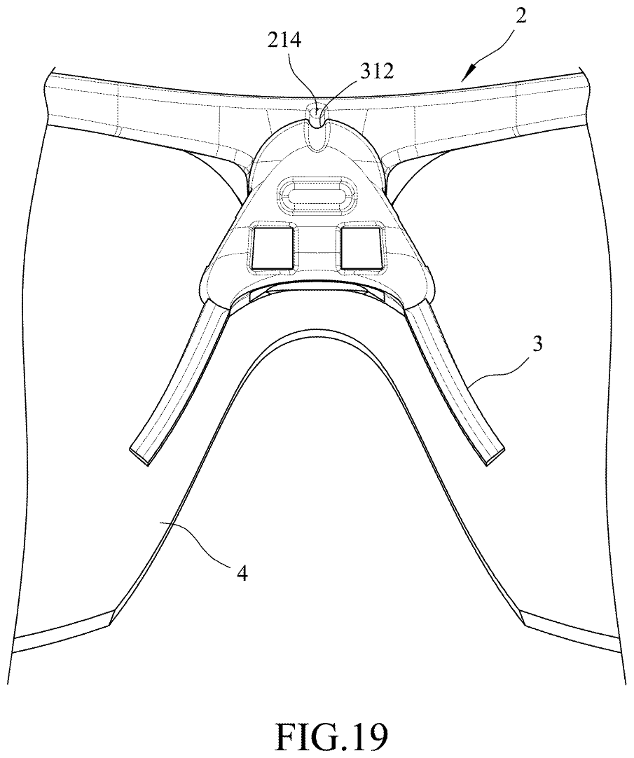

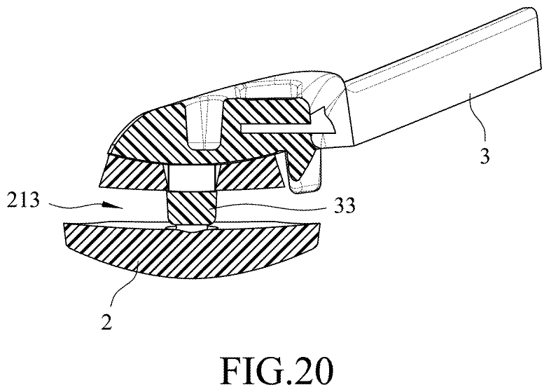

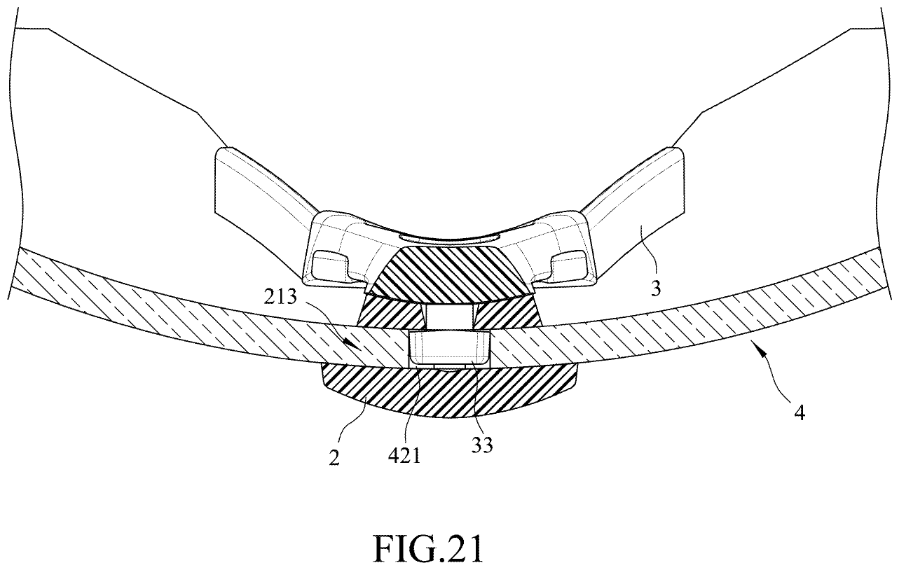

Referring to FIGS. 13 to 20, in this embodiment, to assemble the fastener 3 to the frame 2, the rectangular body segment 33 of the fastener 3 is first aligned with the pivot hole 221 of the frame 2 with the second length (d) thereof parallel to the first length (a) of the pivot hole 221, after which it is inserted into the pivot hole 221, is moved downward and is then pushed forward until the engaging piece 331 of the rectangular body segment 33 engages the engaging groove 231 of the covering portion 23, thereby fixing the fastener 3 to the frame 2. At this time, the abutment surface 311 of the fastener 2 abuts against the rear surface 223 of the engaging portion 22, the rectangular body segment 33 is exposed from the receiving slot 213 of the frame 2, and the protruding rod 32 is rotatably received in the pivot hole 221. Through this, the fastener 3 is rotatable at a predetermined angle relative to the frame 2 between a first position and a second position. In the first position, as shown in FIGS. 16 to 18, the second length (d) of the rectangular body segment 33 is parallel to the first length (a) of the pivot hole 221, the receiving notch 421 of the lens unit 4 can be inserted into or removed from the rectangular body segment 33 through the opening 422 thereof, and the lens portions 41 can be inserted into or detached from the receiving slot 213 of the frame 2. In the second position, as shown in FIGS. 19 and 21, the second length (d) (see FIG. 10) of the rectangular body segment 33 is perpendicular to the first length (a) (see FIG. 7) of the pivot hole 221, the rectangular body segment 33 is retained in the receiving notch 421, and the lens unit 4 is fastened to the frame 2. In this embodiment, the predetermined angle is 90 degrees.

Specifically, to attach the lens unit 4 to the frame 2, the fastener 3 is first rotated 90 degrees either to the left or to the right of the frame 2 so as to be placed in the first position. That is, the fastener 3 is rotated until the center line (W) thereof is parallel to the transverse line (Y) of the frame 2, as shown in FIG. 13, and until the positioning stud 34 is engaged with one of the second positioning grooves 225. Since the rectangular body segment 33 is in a position in which the second length (d) thereof is parallel to the first length (a) of the pivot hole 221, and since the width (e) of the opening 422 of the receiving notch 421 of the lens unit 4 is substantially equal to the first length (c) of the rectangular body segment 33, the lens unit 4 can then be inserted into the rectangular body segment 33 through the opening 422 of the receiving notch 421 of the connecting portion 42 until the top edges of the lens portions 41 are received in the receiving slot 213.

Afterwards, the fastener 3 is rotated 90 degrees downward to the second position until the positioning stud 34 is engaged with the first positioning groove 224. During rotation of the fastener 3 from the first position to the second position, the rectangular body segment 33 thereof also rotates from a position in which the second length (d) thereof is parallel to the first length (a) of the pivot hole 221 to another position that is perpendicular to the first length (a) of the pivot hole 221 and that is received and retained in the receiving section 423 of the receiving notch 421 since the hole diameter (f) of the receiving section 423 is substantially equal to the second length (d) of the rectangular body segment 33. Through engagement of the positioning stud 34 with the first positioning groove 224, and with the rectangular body segment 33 being retained in the receiving section 423 of the receiving notch 421, the lens unit 4 is fastened to the frame 2. During this time, the eyeglasses 100 can be worn by a user.

When the fastener 3 is in the second position, as shown in FIGS. 19 and 21, the first alignment groove 214 is aligned with the second alignment groove 312. This indicates that the frame 2, the fastener 3 and the lens unit 4 are fastened in the correct position.

Conversely, if it is desired to remove the lens unit 4 from the frame 2, the fastener 3 is simply rotated leftward or rightward at an angle of 90 degrees, and the lens unit 4 can be pulled out of the receiving slot 213 of the frame 2 and out of the rectangular body segment 33 of the fastener 3, thereby quickly removing the lens unit 4 from the frame 2 and the fastener 3.

In this embodiment, the protruding block 38 is slidable along the bottom surface 220 of the engaging portion 22 during movement of the fastener 3 between the first and second positions. Further, the covering portion 23 of the frame 2 can cover the rectangular body segment 33 and the receiving notch 421, so that the rectangular body segment 33 and the receiving notch 421 are not exposed and are hidden to thereby enhance the appearance of the eyeglasses 100.

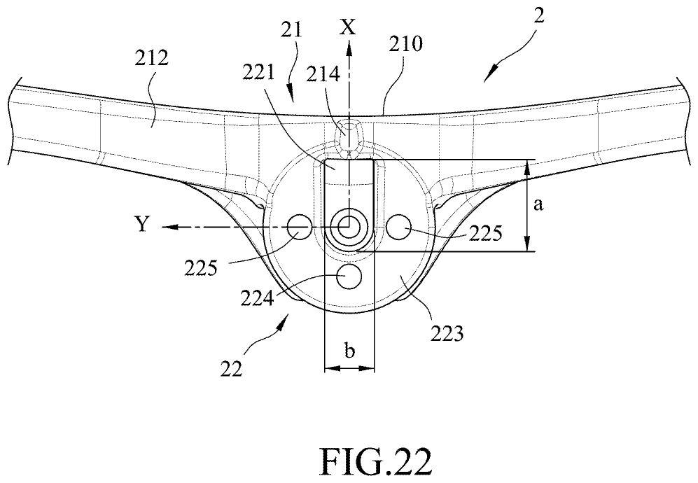

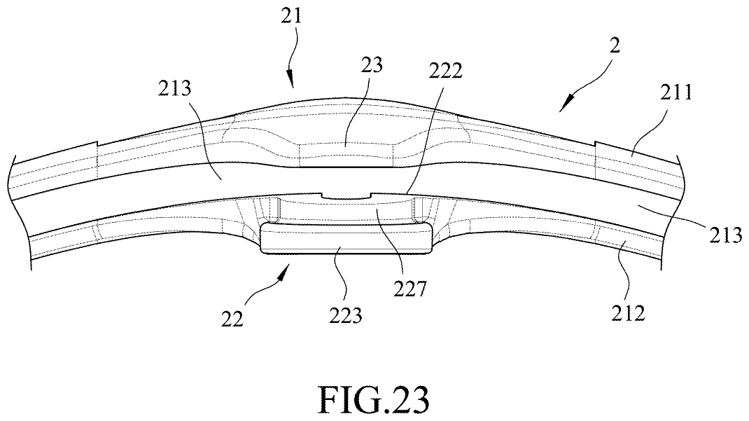

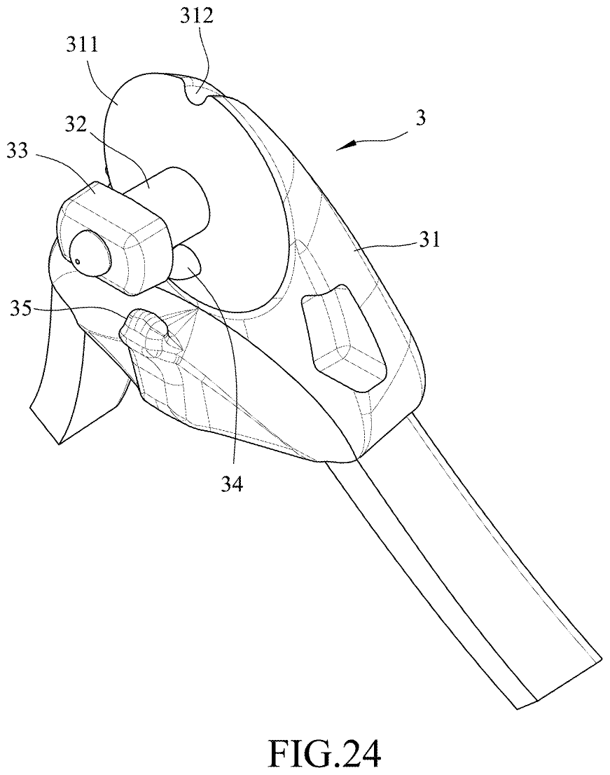

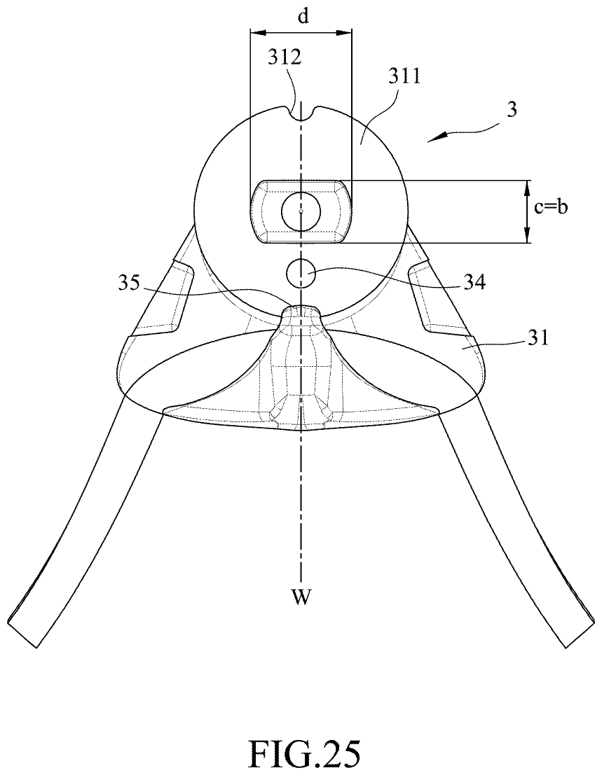

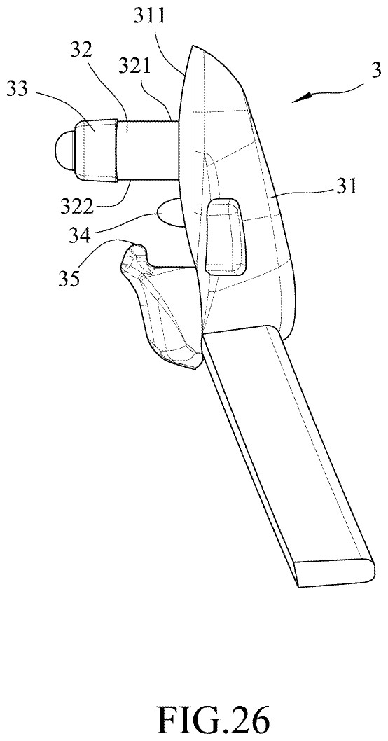

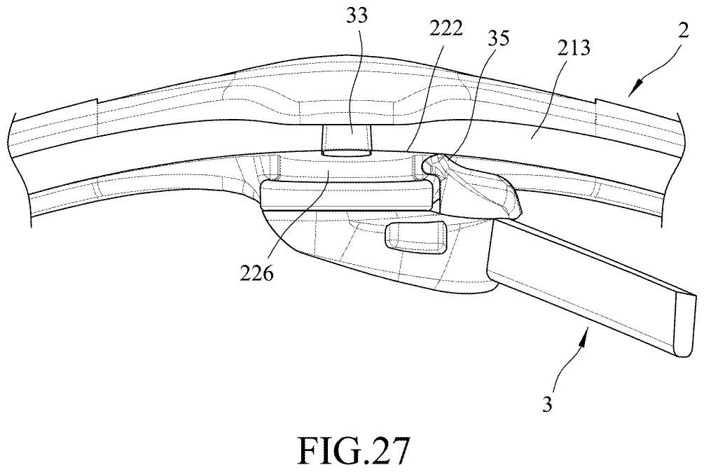

Referring to FIGS. 22 to 27, in the first alternative form of this embodiment, the protruding block 38 of the fastener 3 is replaced by an engaging hook 35, and the bottom surface 220 of the engaging portion 22 of the frame 2 is formed with a U-shaped slide groove 227. When the rectangular body segment 33 of the fastener 3 is inserted into and extends out of the pivot hole 221 of the engaging portion 22 of the frame 2, the engaging hook 35 is engaged with the slide groove 227. The engaging hook 35 is slidable along the slide groove 227 during movement of the fastener 3 between the first and second positions.

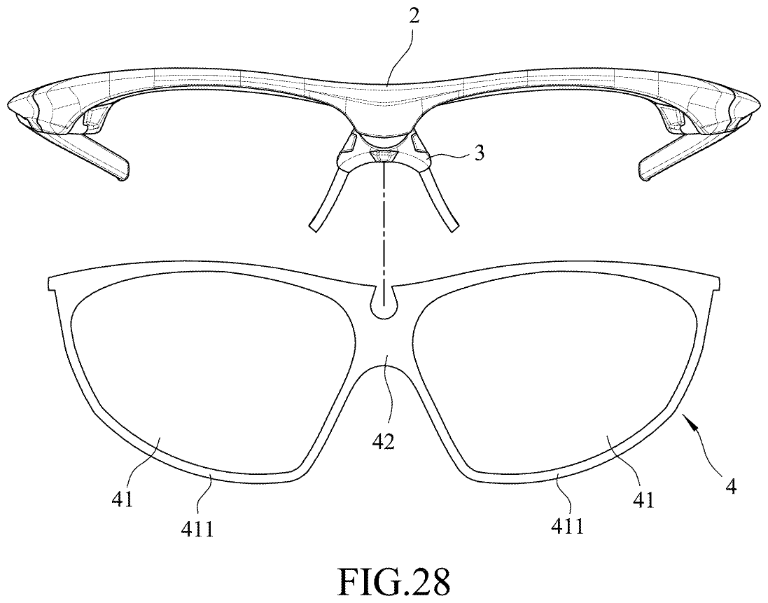

Referring to FIG. 28, in the second alternative form of this embodiment, the lens unit 4 further includes two lens frames 411 each of which surrounds a respective one of the lens portions 41. The lens frames 411 and the connecting portion 42 are integrally formed as one piece, for example, by using a plasticized material.

In sum, through the special configurations of the frame 2 and the fastener 3 of this disclosure, that is, after the fastener 3 has been connected to the frame 2, the user can simply rotate the fastener 3 leftward or rightward at an angle of 90 degrees to the first position to permit quick assembly of the lens unit 4 to the frame 2; and after the lens unit 4 is assembled to the frame 2, the fastener 3 is rotated downward at an angle of 90 degrees to the second position to fasten the lens unit 4 to the frame 2. Further, to detach the lens unit 4 from the frame 2, the fastener 3 is simply rotated leftward or rightward to the first position, and the lens unit 4 can be pulled out of the receiving slot 213 and away from the frame 2. Hence, the lens unit 4 can be quickly attached to and detached from the frame 2. Therefore, the object of this disclosure can indeed be achieved.

While the present disclosure has been described in connection with what is considered the most practical embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. Eyeglasses comprising:
a frame including
a frame main body including a front wall, a rear wail opposite to said front wall, and a top wall connected between top ends of said front and rear walls and cooperating with said front and rear walls to define a receiving slot having a downward opening,
an engaging portion extending downwardly from said rear wall and having a front surface, a rear surface opposite to said front surface, and a pivot hole extending through said front and rear surfaces, and
a covering portion extending downwardly from said front wall and having an engaging groove formed in an inner surface thereof and facing said pivot hole,
said frame having a center line extending in a top-bottom direction, said pivot hole having a first length extending along the center line, and a second length extending along a transverse line perpendicular to the center line and shorter than said first length;
a fastener rotatably connected to said frame and including
a fastener main body having an abutment surface abutting against said rear surface of said engaging portion,
a protruding rod protruding from said abutment surface and rotatably received in said pivot hole, and
a rectangular body segment that is connected to said protruding rod opposite to said abutment surface, that extends out of said pivot hole and that is exposed from said receiving slot, said rectangular body segment having an engaging piece protruding therefrom and engaged to said engaging groove,
said fastener having a center line parallel to the center line of said frame, said rectangular body segment having a first length extending along the center line of said fastener, and a second length extending along a transverse line perpendicular to the center line of said fastener, said first length of said rectangular body segment being substantially equal to said second length of said pivot hole, said second length of said rectangular body segment being shorter than said first length of said pivot hole; and
a lens unit detachably connected to said frame and including
two lens portions having top edges received in said receiving slot, and
a connecting portion connected between said lens portions and having a receiving notch formed in a top edge thereof, said receiving notch having an opening with a width substantially equal to said first length of said rectangular body segment, and a receiving section with a hole diameter that is larger than said width of said opening and that is substantially equal to said second length of said rectangular body segment;
said fastener being rotatable at a predetermined angle relative to said frame between a first position, in which said second length of said rectangular body segment is parallel to said first length of said pivot hole, and said lens unit can be inserted into or removed from said rectangular body segment through said opening of said receiving notch and can be inserted into or detached from said receiving slot of said frame through said lens portions; and a second position, in which said second length of said rectangular body segment is perpendicular to said first length of said pivot hole, said rectangular body segment is received and retained in said receiving section of said receiving notch, and said lens unit is fastened to said frame.

2. The eyeglasses as claimed in claim 1, wherein said frame further includes a covering portion extending downwardly from said front wall for covering said rectangular body segment and said receiving notch.

3. The eyeglasses as claimed in claim 1, wherein said predetermined angle is 90 degrees.

4. The eyeglasses as claimed in claim 3, wherein said rear wall of said frame main body is formed with a first alignment groove at the center thereof, and said fastener main body further has a top surface formed with a second alignment groove at the center thereof, said first and second alignment grooves aligning with each other when said fastener is at said second position.

5. The eyeglasses as claimed in claim 4, wherein said engaging portion further has a substantially U-shaped slide groove formed in said rear surface and located below said pivot hole, and a first positioning groove formed in the center of a groove bottom of said slide groove, said fastener further including a positioning stud protruding forwardly from said abutment surface and located below said protruding rod, said positioning stud being slidable along said U-shaped slide groove when said fastener is rotated relative to said frame between said first and second positions, said positioning stud engaging with said first positioning groove when said fastener is at said second position.

6. The eyeglasses as claimed in claim 5, wherein said engaging portion further has two second positioning grooves formed in said groove bottom of said U-shaped slide groove, said first positioning groove being located between said second positioning grooves, said positioning stud engaging with one of said second positioning grooves when said fastener is rotated from said second position to said first position.

7. The eyeglasses as claimed in claim 1, wherein said engaging portion further has a bottom surface connected between said front and rear surfaces, said bottom surface being formed with a U-shaped slide groove, said fastener further including an engaging hook protruding forwardly from a bottom end of said fastener main body and engaged with said U-shaped slide groove, said engaging hook being slidable along said U-shaped slide groove when said fastener is rotated relative to said frame between said first and second positions.

8. The eyeglasses as claimed in claim 1, wherein said fastener further includes a nose bridge portion formed at a bottom end of said fastener main body, and two nose pads extending downwardly from two opposite ends of said nose bridge portion away from each other.

9. The eyeglasses as claimed in claim 1, wherein said engaging portion further has a bottom surface connected between said front and rear surfaces, said fastener further including a protruding block protruding forwardly from a bottom end of said fastener main body, said protruding block being slidable along said bottom surface of said engaging portion when said fastener is rotated relative to said frame between said first and second positions.

10. The eyeglasses as claimed in claim 1, wherein said lens portions and said connecting portion of said lens unit are integrally formed as a single shield lens.

11. The eyeglasses as claimed in claim 1, wherein said lens unit further includes two lens frames each of which surrounds a respective one of said lens portions, and said lens frames and said connecting portion are integrally formed as one piece.
